(19) United States
(12) Patent Application Publication
(10) Pub. No.: US 2023/0099595 A1
(43) Pub. Date: Mar. 30, 2023

(54) COUPLING STRUCTURE FOR PROPELLER SHAFT AND PROPELLER SHAFT HAVING SAME

(71) Applicant: HITACHI ASTEMO, LTD., Hitachinaka-shi, Ibaraki (JP)

(72) Inventors: Xiaojin ZHU, Hitachinaka-shi, Ibaraki (JP); Kenichiro ISHIKURA, Hitachinaka-shi, Ibaraki (JP)

(73) Assignee: HITACHI ASTEMO, LTD., Hitachinaka-shi, Ibaraki (JP)

(21) Appl. No.: 17/908,309

(22) PCT Filed: Mar. 2, 2021
(86) PCT No.: PCT/JP2021/007882

§ 371 Date: Aug. 31, 2022

(30) Foreign Application Priority Data
Mar. 3, 2020 (JP) 2020-035610

(51) Int. Cl. F16D 1/033; B60K 17/22

(52) U.S. Cl. CPC F16D 1/033; B60K 17/22

(57) ABSTRACT

In a coupling structure for a propeller shaft and a propeller shaft, a propeller shaft-side adapter includes: a flange portion of the propeller shaft-side adapter extending in a radial direction relative to a rotation axis of a rotation shaft, and connected to a flange portion of a vehicle-side adapter; a center pin accommodating portion formed on the rotation axis, and into which a center pin provided to the vehicle-side adapter is inserted; and an inner peripheral portion formed between the flange portion of the propeller shaft-side adapter and the center pin accommodating portion in the radial direction relative to the rotation axis, which is opposed to the vehicle-side adapter in a direction of the rotation axis, and in which a distance from the rotation axis in the radial direction relative thereto decreases extending away from the flange portion of the vehicle-side adapter in the rotation axis direction.

### TECHNICAL FIELD

The present invention relates to a coupling structure for a propeller shaft and a propeller shaft having the coupling structure.

### BACKGROUND ART

In Patent Literature 1, there is disclosed a properller shaft in which, in a first end portion and a second end portion that are both end portions of a CFRP tube, a first joint restricted in movement in a rotation direction is provided to the first end portion, and a second joint capable of moving in the rotation direction is provided to the second end portion.

### CITATION LIST

### Patent Literature

PTL 1: WO 2019/054167 A

### SUMMARY OF INVENTION

### Technical Problem

However, the propeller shaft described in Patent Literature 1 has a lid member provided to the second joint on a rotation axis, and hence there is a problem in that it is very difficult to center a rotation shaft on a vehicle side with the second joint by accommodating the rotation shaft on the vehicle side in the second joint.

SOLUTION TO PROBLEM

One of the objects of the present invention is to provide a coupling structure for a propeller shaft enabling easy assembly of the connection between a vehicle-side adapter coupled to a rotation shaft that rotates and a propeller shaft-side adapter, and a propeller shaft having the coupling structure.

In a coupling structure for a propeller shaft and a propeller shaft having the coupling structure according to one embodiment of the present invention, a propeller shaft-side adapter includes: a flange portion of the propeller shaft-side adapter which extends in a radial direction with respect to a rotation axis of a rotation shaft, and which is connected to a flange portion of a vehicle-side adapter; a center pin accommodating portion which is formed on the rotation axis, and into which a center pin provided to the vehicle-side adapter is inserted; and an inner peripheral portion which is formed between the flange portion of the propeller shaft-side adapter and the center pin accommodating portion in the radial direction with respect to the rotation axis, which is opposed to the vehicle-side adapter in a direction of the rotation axis, and in which a distance from the rotation axis in the radial direction with respect to the rotation axis decreases as extending away from the flange portion of the vehicle-side adapter in the direction of the rotation axis.

According to the coupling structure for a propeller shaft and the propeller shaft having the coupling structure according to one embodiment of the present invention, the connection between the vehicle-side adapter coupled to the rotation shaft that rotates and the propeller shaft-side adapter can easily be assembled.

### BRIEF DESCRIPTION OF DRAWINGS

FIG. 1 is a view for illustrating the entirety of a propeller shaft according to a first embodiment.

FIG. 2 is an enlarged perspective view of a portion A of FIG. 1 according to the first embodiment.

FIG. 3 is an enlarged sectional view of the portion A of FIG. 1 according to the first embodiment.

FIG. 4 is an overall schematic view for illustrating a relationship between a vehicle-side adapter and a propeller shaft-side adapter according to the first embodiment.

FIG. 5 is a sectional view of main parts for illustrating a relationship between the vehicle-side adapter and the propeller shaft-side adapter according to the first embodiment.

FIG. 6 is a time chart 1 for illustrating an assembly process of a coupling structure between the vehicle-side adapter and the propeller shaft-side adapter according to the first embodiment.

FIG. 7 is a time chart 2 for illustrating the assembly process of the coupling structure between the vehicle-side adapter and the propeller shaft-side adapter according to the first embodiment.

FIG. 8 is a time chart 3 for illustrating the assembly process of the coupling structure between the vehicle-side adapter and the propeller shaft-side adapter according to the first embodiment.

### DESCRIPTION OF EMBODIMENTS

### First Embodiment

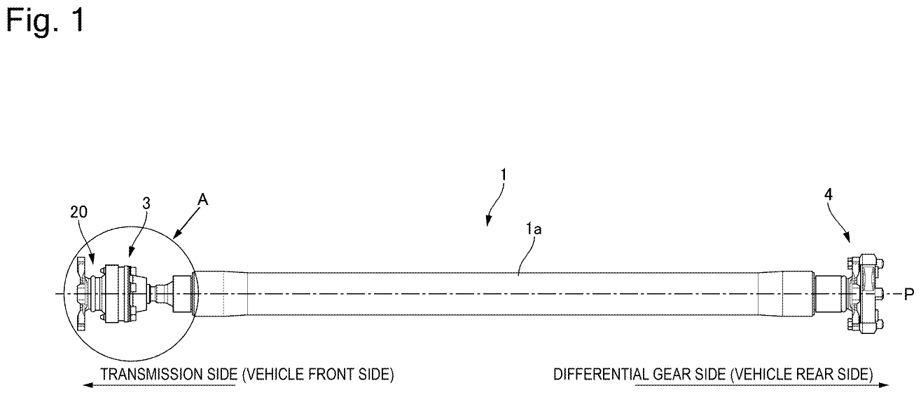

FIG. 1 is a view for illustrating the entirety of a propeller shaft according to a first embodiment.

In the following description, for convenience, description is given with the left side of FIG. 1 being defined as “vehicle front side” and the right side of FIG. 1 being defined as “vehicle rear side”.

### (Configuration of Propeller Shaft)

A propeller shaft 1 includes: a propeller shaft-side adapter (coupling structure) 20 which is coupled to an engine serving as a drive source (not shown), and which is coupled to an output shaft of a transmission located on the vehicle front side so as to be integrally rotatable; a propeller shaft main body portion 1a having an end portion on the vehicle front side being coupled to the propeller shaft-side adapter 20 through intermediation of a constant velocity joint 3; and a propeller shaft-side adapter 4 which couples an end portion of the propeller shaft main body portion la on the vehicle rear side to a differential gear that drives a drive wheel.

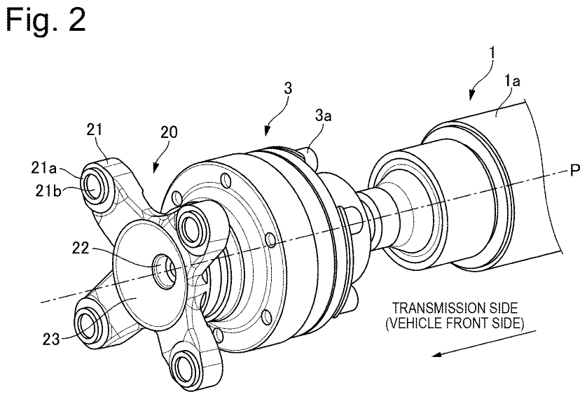

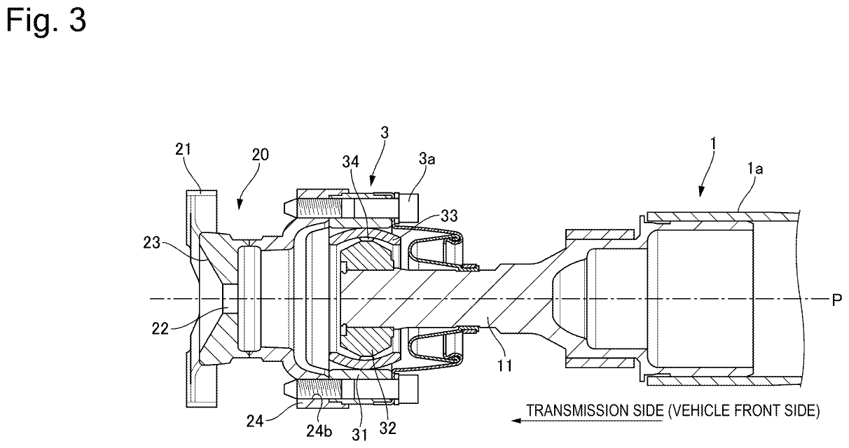

FIG. 2 is an enlarged perspective view of a portion A of FIG. 1 according to the first embodiment. FIG. 3 is an enlarged sectional view of the portion A of FIG. 1 according to the first embodiment.

The configuration of the propeller shaft-side adapter 20 according to the first embodiment is described.

The propeller shaft-side adapter 20 includes: four flange portions 21 each having a protruding portion 21a and a through hole 21b formed on the transmission side (vehicle front side); a center pin accommodating portion 22 into which a center pin 53 of a vehicle-side adapter 50 described later is inserted, and which is formed at the center for axial center alignment between the vehicle-side adapter 50 and the propeller shaft-side adapter 20; an inner peripheral portion 23 which connects the four flange portions 21 and the center pin accommodating portion 22 to each other, and in which a distance in a radial direction with respect to a rotation axis P decreases as extending away from a flange portion 52 of the vehicle-side adapter 50 in a direction of the rotation axis P, that is, which is formed into a linear tapered shape having a predetermined angle with respect to the rotation axis P when viewed in a cross section passing through the rotation axis P; and a companion flange portion (connection portion) 24 which includes through holes 24a each having an internal thread for fixing an outer ring 31 of the constant velocity joint 3 with a bolt 3a and communication holes 24c, and which is formed on the vehicle rear side.

The constant velocity joint 3 includes: a plurality of balls 34 fitted to grooves formed on an inner peripheral surface of the outer ring 31 in the direction of the rotation axis P; a retainer 33 which retains the plurality of balls 34; and an inner ring 32 in which an outer peripheral surface is formed into a curved shape, and grooves for allowing the plurality of balls 34 to be fitted thereto are formed on the outer peripheral surface in the direction of the rotation axis P, and which includes spline teeth formed on an inner peripheral surface of the inner ring 32 engaged with spline teeth formed on an outer peripheral surface of an end portion on the vehicle front side of a shaft 11 of the propeller shaft main body portion la.

With this configuration, the rotational force transmitted from the propeller shaft-side adapter 20 to the outer ring 31 is transmitted to the inner ring 32 via the plurality of balls 34, and further transmitted to the shaft 11 of the propeller shaft main body portion 1a by spline fitting.

The respective rotation shafts of the propeller shaft-side adapter 20 and the propeller shaft main body portion 1a are allowed to be displaced at a predetermined angle around the rotation axis P through the constant velocity joint 3.

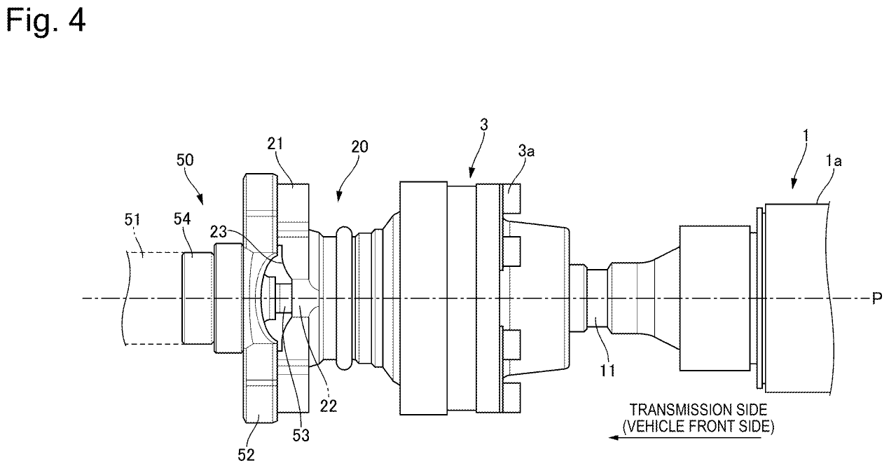

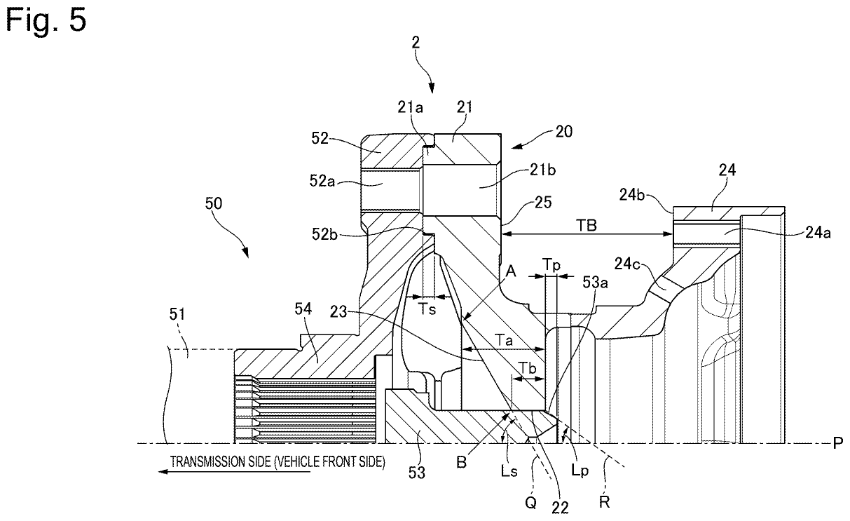

FIG. 4 is an overall schematic view for illustrating a relationship between the vehicle-side adapter and the propeller shaft-side adapter according to the first embodiment, and FIG. 5 is a sectional view of main parts for illustrating a relationship between the vehicle-side adapter and the propeller shaft-side adapter according to the first embodiment.

The vehicle-side adapter (coupling structure) 50 includes: a cylindrical portion 54 having, on an inner peripheral surface thereof, spline teeth engaged with spline teeth formed on an outer peripheral surface of a rotation shaft 51 that is coupled to the output shaft of the transmission on the transmission side (vehicle front side) so as to be integrally rotatable; four flange portions 52 formed so as to be opposed to the four flange portions 21 formed in the propeller shaft-side adapter 20; and the center pin 53 which is accommodated in the center pin accommodating portion 22 formed at the center of the propeller shaft-side adapter 20.

A recess 52b, to which the protruding portion 21a formed in each of the four flange portions 21 formed in the propeller shaft-side adapter 20 is fitted, is formed in each of the four flange portions 52, and a hole portion 52a having an internal thread formed therein in each of the four flange portions 52 so as to overlap with the through hole 21b formed in each of the four flange portions 21 formed in the propeller shaft-side adapter 20.

When a bolt (coupling structure) 2a described later is inserted into each of the through holes 21b respectively formed in the four flange portions 21 formed in the propeller shaft side-adapter 20 and is threadedly engaged with the hole portion 52a of each of the four vehicle-side flange portions 52, the vehicle-side adapter 50 and the propeller shaft-side adapter 20 are fixed to form a coupling structure 2.

In addition, a length Ts (=depth of the recess 52b) in the direction of the rotation axis P of the protruding portion 21a formed in each of the four flange portions 21 formed in the propeller shaft-side adapter 20 is formed smaller than a length Tp of a chamfered portion 53a formed in a distal end portion on the vehicle rear side of the center pin 53 of the vehicle-side adapter 50, which extends off from the center pin accommodating portion 22 of the propeller shaft-side adapter 20 to an opposite side of the vehicle-side flange portion 52, that is, to the vehicle rear side.

With this configuration, before the protruding portion 21a of the propeller shaft-side adapter 20 and the recess 52b of the vehicle-side adapter 50 are fitted to each other, the center pin 53 of the vehicle-side adapter 50 can be inserted into the center pin accommodating portion 22 of the propeller shaft-side adapter 20. As a result, the axial center alignment between the propeller shaft-side adapter 20 and the vehicle-side adapter 50 can reliably be performed, and the protruding portion 21a of the propeller shaft-side adapter 20 and the recess 52b of the vehicle-side adapter 50 can smoothly be fitted to each other.

Further, a thickness Ta in the direction of the rotation axis P at a point A of the inner peripheral portion 23 formed in the propeller shaft-side adapter 20 is formed larger than a thickness Tb in the direction of the rotation axis P at a point B of the center pin accommodating portion 22 formed in the propeller shaft-side adapter 20.

With this configuration, the strength of the propeller shaft-side adapter 20 can be maintained.

In addition, an angle Ls formed by an imaginary line Q of the inner peripheral portion 23 of the propeller shaft-side adapter 20 and the rotation axis P is formed larger than an angle Lp formed by an imaginary line R of the chamfered portion 53a formed in the distal end portion on the vehicle rear side of the center pin 53 of the vehicle-side adapter 50 and the rotation axis P.

With this configuration, at the time of assembly, the chamfered portion 53a formed in the distal end portion on the vehicle rear side of the center pin 53 of the vehicle-side adapter 50 can smoothly move in the inner peripheral portion 23 of the propeller shaft-side adapter 20, and ease of assembly can be improved.

Further, the protruding portion 21a of each of the four flange portions 21 of the propeller shaft-side adapter 20 and the recess 52b of each of the four flange portions 52 of the vehicle-side adapter 50 are fitted to each other. Then, the bolt 2a is inserted into each of the through holes 21b of the four flange portions 21 of the propeller shaft-side adapter 20 and is threadedly engaged with the internal thread of the hole portion 52a of each of the four flange portions 52 of the vehicle-side adapter 50. Thus, as mentioned above, the vehicle-side adapter 50 and the propeller shaft-side adapter 20 are fixed to form the coupling structure 2.

With this configuration, the axial force of the bolt 2a is received by an end surface on the vehicle front side of the protruding portion 21a of each of the four flange portions 21 of the propeller shaft-side adapter 20 and a bottom surface of the recess 52b of each of the four flange portions 52 of the vehicle-side adapter 50, and hence the axial force can easily be transmitted.

In addition, a length TB between an opposed surface 25 of each of the four flange portions 21 of the propeller shaft-side adapter 20 with respect to the companion flange portion 24 and an end surface 24b of the companion flange portion 24 on the vehicle front side is formed larger than the length of the bolt 2a.

With this configuration, ease of operation at the time of fastening with the bolts 2a between the four flange portions 21 of the propeller shaft-side adapter 20 and the four flange portions 52 of the vehicle-side adapter 50 can be improved.

Further, in the companion flange portion 24, the communication holes 24c each allowing an outside and an inside of the companion flange portion 24 to communicate to each other are formed.

With this configuration, it is possible to suppress an increase in internal pressure caused by the movement of the inner ring 32 fixed to the shaft 11 of the propeller shaft main body portion la of the constant velocity joint 3 in which the outer ring 31 is fixed to the companion flange portion 24 with respect to the outer ring 31 in the direction of the rotation axis P.

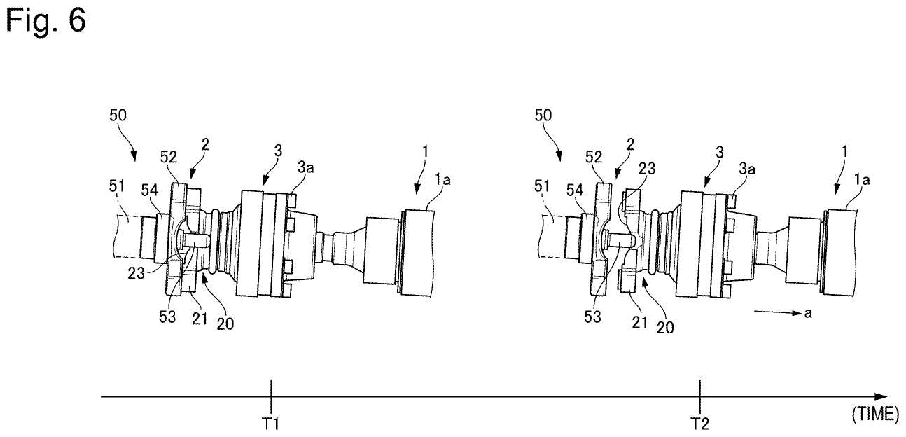

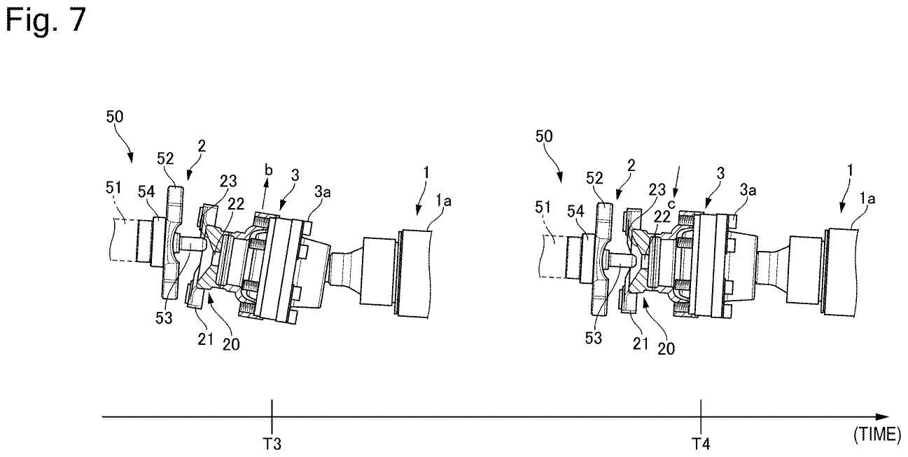

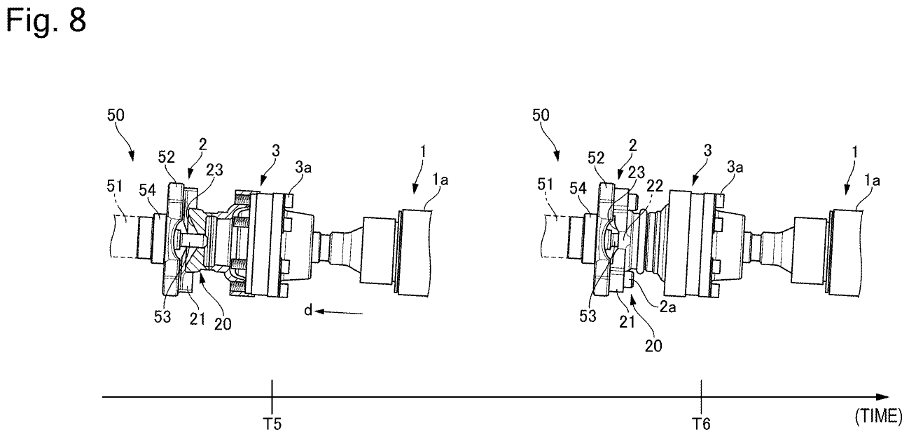

FIG. 6 is a time chart 1 for illustrating an assembly process of the coupling structure between the vehicle-side adapter and the propeller shaft-side adapter according to the first embodiment. FIG. 7 is a time chart 2 for illustrating the assembly process of the coupling structure between the vehicle-side adapter and the propeller shaft-side adapter according to the first embodiment. FIG. 8 is a time chart 3 for illustrating the assembly process of the coupling structure between the vehicle-side adapter and the propeller shaft-side adapter according to the first embodiment.

The assembly of the coupling structure 2 between the vehicle-side adapter 50 and the propeller shaft-side adapter 20 includes: a pre-assembly state (time T1); the step of contracting the propeller shaft-side adapter 20 and the outer ring 31 of the constant velocity joint 3 (time T2); the step of bending the propeller shaft-side adapter 20 and the outer ring 31 of the constant velocity joint 3 (time T3); the step of returning the bending of the propeller shaft-side adapter 20 and the outer ring 31 of the constant velocity joint 3 (time T4); the step of extending the propeller shaft-side adapter 20 and the outer ring 31 of the constant velocity joint 3 (time T5); and the step of fixing the propeller shaft-side adapter 20 and the vehicle-side adapter 50 with the bolts 2a (time T6). Now, the above-mentioned assembly is described in sequence.

As illustrated in FIG. 6, the pre-assembly state (time T1) is a state in which the rotation axes of the vehicle-side adapter 50 and the propeller shaft-side adapter 20 are displaced from each other, that is, the center pin 53 of the vehicle-side adapter 50 is located between the two flange portions 21 of the propeller shaft-side adapter 20 to interfere with the propeller shaft-side adapter 20.

As illustrated in FIG. 6, the step of contracting the propeller shaft-side adapter 20 and the outer ring 31 of the constant velocity joint 3 (time T2) is the step of moving the propeller shaft-side adapter 20 and the outer ring 31 of the constant velocity joint 3 with respect to the inner ring 32 of the constant velocity joint 3 so as to contract the propeller shaft-side adapter 20 and the outer ring 31 of the constant velocity joint 3 in the direction indicated by the arrow “a”.

However, the center pin 53 of the vehicle-side adapter 50 is located between the two flange portions 21 of the propeller shaft-side adapter 20 and is still arranged at a position of interfering with the propeller shaft-side adapter 20.

As illustrated in FIG. 7, the step of bending the propeller shaft-side adapter 20 and the outer ring 31 of the constant velocity joint 3 (time T3) is the step of moving the propeller shaft-side adapter 20 and the outer ring 31 of the constant velocity joint 3 with respect to the inner ring 32 of the constant velocity joint 3 so as to bend the propeller shaft-side adapter 20 and the outer ring 31 of the constant velocity joint 3 in the direction indicated by the arrow “b”.

In this case, the center pin 53 of the vehicle-side adapter 50 is arranged in a space formed by the inner peripheral portion 23 having a tapered shape formed of a straight line of the propeller shaft-side adapter 20, and is arranged at a position of not interfering with the propeller shaft-side adapter 20.

As illustrated in FIG. 7, the step of returning the bending of the propeller shaft-side adapter 20 and the outer ring 31 of the constant velocity joint 3 (time T4) is the step of moving the propeller shaft-side adapter 20 and the outer ring 31 of the constant velocity joint 3 in the direction indicated by the arrow “c” with respect to the inner ring 32 of the constant velocity joint 3 so as to return the bending of the propeller shaft-side adapter 20 and the outer ring 31 of the constant velocity joint 3 to the original state.

In this case, the center pin 53 of the vehicle-side adapter 50 arranged in the space formed by the inner peripheral portion 23 having a tapered shape formed of a straight line of the propeller shaft-side adapter 20 can be arranged at a position opposed to the center pin accommodating portion 22 of the propeller shaft-side adapter 20 without being caught in the propeller shaft-side adapter 20 to interfere therewith.

In addition, the inner peripheral portion 23 is formed into a tapered shape formed of a straight line, and hence the strength of the propeller shaft-side adapter 20 can also be ensured.

As illustrated in FIG. 8, the step of extending the propeller shaft-side adapter 20 and the outer ring 31 of the constant velocity joint 3 (time T5) is the step of moving the propeller shaft-side adapter 20 and the outer ring 31 of the constant velocity joint 3 with respect to the inner ring 32 of the constant velocity joint 3 so as to extend the propeller shaft-side adapter 20 and the outer ring 31 of the constant velocity joint 3 in the direction indicated by the arrow “d”.

Due to this movement, the center pin 53 of the vehicle-side adapter 50 is accommodated in the center pin accommodating portion 22 of the propeller shaft-side adapter 20, and the protruding portion 21a formed in each of the four flange portions 21 formed in the propeller shaft-side adapter 20 is fitted to the recess 52b formed in each of the four flange portions 52 formed in the vehicle-side adapter 50.

As illustrated in FIG. 8, in the step of fixing the propeller shaft-side adapter 20 and the vehicle-side adapter 50 with the bolts 2a (time T6), the bolt 2a is inserted into each of the through holes 21b of the four flange portions 21 of the propeller shaft-side adapter 20 and is threadedly engaged with the internal thread of the hole portion 52a of each of the four flange portions 52 of the vehicle-side adapter 50, and as a result, the vehicle-side adapter 50 and the propeller shaft-side adapter 20 are fixed to form the coupling structure 2.

The vehicle-side adapter 50 and the propeller shaft-side adapter 20 are coupled to each other as described above, and hence the center pin 53 of the vehicle-side adapter 50 can be prevented from interfering with the propeller shaft-side adapter 20 at the time of assembly.

Next, the action and effect are described.

The action and effect of the coupling structure for a propeller shaft and the propeller shaft having the coupling structure according to the first embodiment are described below.

(1) The propeller shaft-side adapter 20 is set to include: the four flange portions 21 each having the protruding portion 21a and the through hole 21b formed on the transmission side (vehicle front side); the center pin accommodating portion 22 into which the center pin 53 of the vehicle-side adapter 50 described later is inserted, and which is formed at the center for axial center alignment between the vehicle-side adapter 50 and the propeller shaft-side adapter 20; the inner peripheral portion 23 which connects the four flange portions 21 and the center pin accommodating portion 22 to each other, and in which a distance in the radial direction with respect to the rotation axis P decreases as extending away from the flange portion 52 of the vehicle-side adapter 50 in the direction of the rotation axis P; and the companion flange portion 24 which includes the through holes 24a each having an internal thread for fixing the outer ring 31 of the constant velocity joint 3 with the bolt 3a and the communication holes 24c, and which is formed on the vehicle rear side.

With this configuration, the vehicle-side adapter 50 and the propeller shaft-side adapter 20 are coupled to each other, and hence the center pin 53 of the vehicle-side adapter 50 can be prevented from interfering with the propeller shaft-side adapter 20 at the time of assembly.

(2) The inner peripheral portion 23 of the propeller shaft-side adapter 20 is set to be formed into a tapered shape when viewed in a cross section passing through the rotation axis P.

With this configuration, the center pin 53 of the vehicle-side adapter 50 can be prevented from being caught by the inner peripheral portion 23 of the propeller shaft-side adapter 20.

(3) The inner peripheral portion 23 of the propeller shaft-side adapter 20 is set to be formed into a tapered shape formed of a straight line when viewed in a cross section passing through the rotation axis P.

With this configuration, the strength of the propeller shaft-side adapter 20 can also be ensured.

(4) The thickness Ta in the direction of the rotation axis P at the point A of the inner peripheral portion 23 formed in the propeller shaft-side adapter 20 is set to be formed larger than the thickness Tb in the direction of the rotation axis P at the point B of the center pin accommodating portion 22 formed in the propeller shaft-side adapter 20.

With this configuration, the strength of the propeller shaft-side adapter 20 can be maintained.

(5) The angle Ls formed by the imaginary line Q of the inner peripheral portion 23 of the propeller shaft-side adapter 20 and the rotation axis P is set to be formed larger than the angle Lp formed by the imaginary line R of the chamfered portion 53a formed in the distal end portion on the vehicle rear side of the center pin 53 of the vehicle-side adapter 50 and the rotation axis P.

With this configuration, at the time of assembly, the chamfered portion 53a formed in the distal end portion on the vehicle rear side of the center pin 53 of the vehicle-side adapter 50 can smoothly move in the inner peripheral portion 23 of the propeller shaft-side adapter 20, and ease of assembly can be improved.

(6) The protruding portion 21a of each of the four flange portions 21 of the propeller shaft-side adapter 20 and the recess 52b of each of the four flange portions 52 of the vehicle-side adapter 50 are fitted to each other. Then, the bolt 2a is inserted into each of the through holes 21b of the four flange portions 21 of the propeller shaft-side adapter 20 and is threadedly engaged with the internal thread of the hole portion 52a of each of the four flange portions 52 of the vehicle-side adapter 50. As a result, the vehicle-side adapter 50 and the propeller shaft-side adapter 20 are set to be fixed to form the coupling structure 2.

With this configuration, the axial force of the bolt 2a is received by the end surface on the vehicle front side of the protruding portion 21a of each of the four flange portions 21 of the propeller shaft-side adapter 20 and the bottom surface of the recess 52b of each of the four flange portions 52 of the vehicle-side adapter 50, and hence the axial force can easily be transmitted.

(7) The length Ts (=depth of the recess 52b) in the direction of the rotation axis P of the protruding portion 21a formed in each of the four flange portions 21 formed in the propeller shaft-side adapter 20 is set to be formed smaller than the length Tp of the chamfered portion 53a formed in the distal end portion on the vehicle rear side of the center pin 53 of the vehicle-side adapter 50, which extends off from the center pin accommodating portion 22 of the propeller shaft-side adapter 20 to an opposite side of the vehicle-side flange portion 52, that is, to the vehicle rear side.

With this configuration, before the protruding portion 21a of the propeller shaft-side adapter 20 and the recess 52b of the vehicle-side adapter 50 are fitted to each other, the center pin 53 of the vehicle-side adapter 50 can be inserted into the center pin accommodating portion 22 of the propeller shaft-side adapter 20. As a result, the axial center alignment between the propeller shaft-side adapter 20 and the vehicle-side adapter 50 can reliably be performed, and the protruding portion 21a of the propeller shaft-side adapter 20 and the recess 52b of the vehicle-side adapter 50 can smoothly be fitted to each other.

(8) The length TB between the opposed surface 25 of each of the four flange portions 21 of the propeller shaft-side adapter 20 with respect to the companion flange portion 24 and the end surface 24b of the companion flange portion 24 on the vehicle front side is set to be formed larger than the length of the bolt 2a.

With this configuration, ease of operation at the time of fastening with the bolts 2a between the four flange portions 21 of the propeller shaft-side adapter 20 and the four flange portions 52 of the vehicle-side adapter 50 can be improved.

(9) In the companion flange portion 24, the communication holes 24c each allowing an outside and an inside of the companion flange portion 24 to communicate to each other are formed.

With this configuration, it is possible to suppress an increase in internal pressure caused by the movement of the inner ring 32 fixed to the shaft 11 of the propeller shaft main body portion 1a of the constant velocity joint 3 in which the outer ring 31 is fixed to the companion flange portion 24 with respect to the outer ring 31 in the direction of the rotation axis P.

### Other Embodiments

The embodiment of the present invention has been described above. However, the specific configuration of the present invention is not limited to the configuration described in the embodiment. A modification in design without departing from the scope of the gist of the invention is also encompassed in the present invention.

For example, description has been given that the inner peripheral portion 23 of the propeller shaft-side adapter 20 is formed into a linear tapered shape when viewed in a cross section passing through the rotation axis P, but the inner peripheral portion 23 may be formed into a curved tapered shape.

Technical ideas obtained from the embodiments described above are listed below.

According to one aspect, there is provided a coupling structure for a propeller shaft, the propeller shaft including a propeller shaft-side adapter connected to a flange portion of a vehicle-side adapter coupled to a rotation shaft that rotates, and the propeller shaft-side adapter including: a flange portion of the propeller shaft-side adapter connected to the flange portion of the vehicle-side adapter, the flange portion extending in a radial direction with respect to a rotation axis of the rotation shaft; a center pin accommodating portion which is formed on the rotation axis, and into which a center pin provided to the vehicle-side adapter is inserted; and an inner peripheral portion which is formed between the flange portion of the propeller shaft-side adapter and the center pin accommodating portion in the radial direction with respect to the rotation axis, which is opposed to the vehicle-side adapter in a direction of the rotation axis, and in which a distance from the rotation axis in the radial direction with respect to the rotation axis decreases as extending away from the flange portion of the vehicle-side adapter in the direction of the rotation axis.

According to a more preferred aspect, in the above-mentioned aspect, when viewed in a cross section passing through the rotation axis, the inner peripheral portion is formed into a tapered shape.

According to still another preferred aspect, in any one of above-mentioned aspects, when viewed in a cross section passing through the rotation axis, the inner peripheral portion is formed into a linear shape.

According to still another preferred aspect, in any one of above-mentioned aspects, when viewed in a cross section passing through the rotation axis, a thickness in the direction of the rotation axis of the inner peripheral portion formed on a side of the flange portion of the propeller shaft-side adapter is larger than a thickness in the direction of the rotation axis of the inner peripheral portion formed on a side of the center pin accommodating portion.

According to still another preferred aspect, in any one of above-mentioned aspects, when viewed in a cross section passing through the rotation axis, an angle formed by an imaginary line extending along the inner peripheral portion and the rotation axis is larger than an angle formed by an imaginary line extending along a chamfered portion of the center pin and the rotation axis.

According to still another preferred aspect, in any one of above-mentioned aspects, the flange portion of the propeller shaft-side adapter includes: a protruding portion which protrudes toward the flange portion of the vehicle-side adapter, and which is accommodated in a recess of the flange portion of the vehicle-side adapter; and a through hole which is formed in the protruding portion, which penetrates through the protruding portion toward the flange portion of the vehicle-side adapter, which overlaps with a hole portion formed in the recess of the flange portion of the vehicle-side adapter, and into which a bolt configured to fasten the flange portion of the vehicle-side adapter and the flange portion of the propeller shaft-side adapter is inserted.

According to still another preferred aspect, in any one of above-mentioned aspects, a length in the direction of the rotation axis of the protruding portion protruding toward the flange portion of the vehicle-side adapter in the flange portion of the propeller shaft-side adapter is smaller than a length in the direction of the rotation axis of the center pin extending off the center pin accommodating portion toward an opposite side of the flange portion of the vehicle-side adapter.

According to still another preferred aspect, in any one of above-mentioned aspects, the flange portion of the propeller shaft-side adapter includes: a through hole into which a bolt configured to fasten the flange portion of the vehicle-side adapter and the flange portion of the propeller shaft-side adapter is inserted; and an opposed surface in which the through hole is opened, and which is opposed to a companion flange portion coupled to the propeller shaft, and a length from the opposed surface to the companion flange portion is larger than a length of the bolt.

According to still another preferred aspect, in any one of above-mentioned aspects, the propeller shaft-side adapter includes a companion flange portion coupled to the propeller shaft on an opposite side of the flange portion of the vehicle-side adapter, and the companion flange portion includes a communication hole configured to allow an outside and an inside of the companion flange portion to communicate to each other.

According to one aspect, there is provided a propeller shaft connected to a flange portion of a vehicle-side adapter coupled to a rotation shaft that rotates, the propeller shaft including: a propeller shaft main body portion; and a propeller shaft-side adapter which is provided in one end portion of the propeller shaft main body portion, and which is connected to the flange portion of the vehicle-side adapter, and the propeller shaft-side adapter including: a flange portion of the propeller shaft-side adapter connected to the flange portion of the vehicle-side adapter; a connection portion connected to the propeller shaft main body portion; a center pin accommodating portion which is formed between the flange portion of the propeller shaft-side adapter and the connection portion in a direction of a rotation axis of the rotation shaft, and into which a center pin provided to the vehicle-side adapter is inserted; and an inner peripheral portion which is formed between the flange portion of the propeller shaft-side adapter and the center pin accommodating portion in a radial direction with respect to the rotation axis, which is opposed to the vehicle-side adapter in the direction of the rotation axis, and in which a distance from the rotation axis in the radial direction with respect to the rotation axis decreases as extending away from the vehicle-side adapter in the direction of the rotation axis.

Note that, the present invention is not limited to the embodiments described above, and includes further various modification examples. For example, in the embodiments described above, the configurations are described in detail in order to clearly describe the present invention, but the present invention is not necessarily limited to an embodiment that includes all the configurations that have been described. Further, a part of the configuration of a given embodiment can replace the configuration of another embodiment, and the configuration of another embodiment can also be added to the configuration of a given embodiment. Further, another configuration can be added to, deleted from, or replace a part of the configuration of each of the embodiments.

The present application claims a priority based on Japanese Patent Application No. 2020-035610 filed on Mar. 3, 2020. All disclosed contents including Specification, Scope of Claims, Drawings, and Abstract of Japanese Patent Application No. 2020-035610 filed on Mar. 3, 2020 are incorporated herein by reference in their entirety.

### REFERENCE SIGNS LIST

1 propeller shaft, 1a propeller shaft main body portion, 2 coupling structure, 2a bolt (coupling structure), 20 propeller shaft-side adapter (coupling structure), 21 flange portion on propeller shaft side, 21a protruding portion, 21b through hole, 22 center pin accommodating portion, 23 inner peripheral portion, 24 companion flange portion (connection portion), 24b end surface, 24c communication hole, 25 opposed surface, 50 vehicle-side adapter (coupling structure), 51 rotation shaft, 52 flange portions of vehicle-side adapter, 52a hole portion, 52b recess, 53 center pin, 53a chamfered portion, P rotation axis, Q imaginary line extending along inner peripheral portion, R imaginary line extending along chamfered portion of center pin, Ls angle formed by imaginary line extending along inner peripheral portion and rotation axis, Lp angle formed by imaginary line extending along chamfered portion of center pin and rotation axis, Ta thickness in direction of rotation axis of inner peripheral portion formed on side of flange portion of propeller shaft-side adapter, Tb thickness in direction of rotation axis of inner peripheral portion formed on side of center pin accommodating portion formed in propeller shaft-side adapter, Ts length of protruding portion

1. A coupling structure for a propeller shaft,
the propeller shaft includes a propeller shaft-side adapter connected to a flange portion of a vehicle-side adapter coupled to a rotation shaft that rotates,
the propeller shaft-side adapter includes:
a flange portion of the propeller shaft-side adapter connected to the flange portion of the vehicle-side adapter, the flange portion extending in a radial direction with respect to a rotation axis of the rotation shaft;
a center pin accommodating portion which is formed on the rotation axis, and into which a center pin provided to the vehicle-side adapter is inserted; and
an inner peripheral portion which is formed between the flange portion of the propeller shaft-side adapter and the center pin accommodating portion in the radial direction with respect to the rotation axis, which is opposed to the vehicle-side adapter in a direction of the rotation axis, and in which a distance from the rotation axis in the radial direction with respect to the rotation axis decreases as extending away from the flange portion of the vehicle-side adapter in the direction of the rotation axis.

2. The coupling structure for a propeller shaft according to claim 1, wherein, when viewed in a cross section passing through the rotation axis, the inner peripheral portion is formed into a tapered shape.

3. The coupling structure for a propeller shaft according to claim 1, wherein, when viewed in a cross section passing through the rotation axis, the inner peripheral portion is formed into a linear shape.

4. The coupling structure for a propeller shaft according to claim 1, wherein, when viewed in a cross section passing through the rotation axis, a thickness in the direction of the rotation axis of the inner peripheral portion formed on a side of the flange portion of the propeller shaft-side adapter is larger than a thickness in the direction of the rotation axis of the inner peripheral portion formed on a side of the center pin accommodating portion.

5. The coupling structure for a propeller shaft according to claim 1, wherein, when viewed in a cross section passing through the rotation axis, an angle formed by an imaginary line extending along the inner peripheral portion and the rotation axis is larger than an angle formed by an imaginary line extending along a chamfered portion of the center pin and the rotation axis.

6. The coupling structure for a propeller shaft according to claim 1,
wherein the flange portion of the propeller shaft-side adapter includes:
a protruding portion which protrudes toward the flange portion of the vehicle-side adapter, and which is accommodated in a recess of the flange portion of the vehicle-side adapter; and
a through hole which is formed in the protruding portion, which penetrates through the protruding portion toward the flange portion of the vehicle-side adapter, which overlaps with a hole portion formed in the recess of the flange portion of the vehicle-side adapter, and into which a bolt configured to fasten the flange portion of the vehicle-side adapter and the flange portion of the propeller shaft-side adapter is inserted.

7. The coupling structure for a propeller shaft according to claim 1,
wherein a length in the direction of the rotation axis of the protruding portion protruding toward the flange portion of the vehicle-side adapter in the flange portion of the propeller shaft-side adapter is smaller than a length in the direction of the rotation axis of the center pin extending off the center pin accommodating portion toward an opposite side of the flange portion of the vehicle-side adapter.

8. The coupling structure for a propeller shaft according to claim 1,
wherein the flange portion of the propeller shaft-side adapter includes:
a through hole into which a bolt configured to fasten the flange portion of the vehicle-side adapter and the flange portion of the propeller shaft-side adapter is inserted; and
an opposed surface in which the through hole is opened, and which is opposed to a companion flange portion coupled to the propeller shaft, and
wherein a length from the opposed surface to the companion flange portion is larger than a length of the bolt.

9. The coupling structure for a propeller shaft according to claim 1,
wherein the propeller shaft-side adapter includes a companion flange portion coupled to the propeller shaft on an opposite side of the flange portion of the vehicle-side adapter, and
wherein the companion flange portion includes a communication hole configured to allow an outside and an inside of the companion flange portion to communicate to each other.

10. A propeller shaft connected to a flange portion of a vehicle-side adapter coupled to a rotation shaft that rotates, the propeller shaft comprising:
a propeller shaft main body portion; and
a propeller shaft-side adapter which is provided in one end portion of the propeller shaft main body portion, and which is connected to the flange portion of the vehicle-side adapter,
wherein the propeller shaft-side adapter includes:
a flange portion of the propeller shaft-side adapter connected to the flange portion of the vehicle-side adapter;
a connection portion connected to the propeller shaft main body portion;
a center pin accommodating portion which is formed between the flange portion of the propeller shaft-side adapter and the connection portion in a direction of a rotation axis of the rotation shaft, and into which a center pin provided to the vehicle-side adapter is inserted; and
an inner peripheral portion which is formed between the flange portion of the propeller shaft-side adapter and the center pin accommodating portion in a radial direction with respect to the rotation axis, which is opposed to the vehicle-side adapter in the direction of the rotation axis, and in which a distance from the rotation axis in the radial direction with respect to the rotation axis decreases as extending away from the vehicle-side adapter in the direction of the rotation axis.
